(19) United States
(12) Patent Application Publication
(10) Pub. No.: US 2026/0362165 A1
(43) Pub. Date: Nov. 12, 2026

(54) DIRECTING NON-FIXED ACCESS NETWORK RESOURCES IN EMERGENCY SITUATIONS

(71) Applicant: T-Mobile USA, Inc., Bellevue, WA (US)

(72) Inventor: Manoj Gupta, Bellevue, WA (US)

(73) Assignee: T-Mobile USA, Inc., (omitted)

(21) Appl. No.: 19/201,564

(22) Filed: May 7, 2025

(51) Int. Cl. H04W 24/02; H04W 4/02; H04W 4/90

(52) U.S. Cl. CPC H04W 24/02; H04W 4/02; H04W 4/90

(57) ABSTRACT

Described herein are one or more computing devices configured to provide locations to an emergency coverage assessor in an emergency situation and receive, in response, instructions to redeploy non-terrestrial networks (NTNs) or non-fixed terrestrial networks (TNs) to emergency locations of users. The computing device(s) may determine that a geographic area is affected by an emergency situation and, in response, retrieve the emergency locations of users associated with the geographic area. The computing device(s) may provide those emergency locations and locations of at least one of NTNs or non-fixed TNs to the emergency coverage assessor and receive the instructions from the emergency coverage assessor to redeploy an NTN or non-fixed TN to at least one of the emergency locations. The computing device(s) may send sending those instructions to the NTN or non-fixed TN or to a service managing the NTN or non-fixed TN.

### BACKGROUND

Non-terrestrial networks (NTNs), including satellite-provided access networks, drone-provided access networks, and other aerial or space-based access networks, increasingly provide coverage to telecommunications devices, especially in locations underserved or not served by terrestrial networks (e.g., cellular networks, WiFi networks, etc.). Mobile or vehicular terrestrial networks may supplement these increased offerings by NTNs. NTNs and mobile/vehicular terrestrial networks may have set paths or coverage locations not directed or coordinated by a telecommunications network operator, which may complicate providing coverage where it is needed. In emergency situation, novel or unanticipated coverage needs may arise—all users may be directed to shelter at a particular location, for example. Terrestrial networks and NTNs, however, may not be configured to or able to serve users in a desired manner at that location.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 is an overview diagram showing an emergency coverage assessor retrieving emergency locations of users in an emergency situation and, based on those emergency locations and locations of non-terrestrial networks (NTNs) and/or non-fixed terrestrial networks (TNs), providing instructions to redeploy those NTNs and/or non-fixed TNs to provide coverage for the users at their emergency locations.

FIG. 2 is a network architecture diagram of user equipments (UEs), NTNs and/or non-fixed TNs providing coverage to those UEs, a core network connecting to the access networks provided by the NTNs and/or non-fixed TNs, and one or more computing device(s) using emergency locations of UEs and locations of NTNs and/or fixed TNs to redeploy the NTNs and/or non-fixed TNs to the emergency locations of the UEs.

FIG. 3 is a flow diagram of an illustrative process for retrieving emergency locations of users affected by an emergency situation, providing those locations and locations of NTNs or non-fixed TNs to an emergency coverage assessor, receiving instructions from the emergency coverage assessor to redeploy an NTN or non-fixed TN, and sending those instructions to the NTN or non-fixed TN.

FIG. 4 is a schematic diagram of a computing device capable of implementing functionality of at least one of the systems described herein.

### DETAILED DESCRIPTION

This disclosure is directed in part to computing device(s) configured to provide locations to an emergency coverage assessor in an emergency situation and receive, in response, instructions to redeploy non-terrestrial networks (NTNs) or non-fixed terrestrial networks (TNs) to emergency locations of users. The computing device(s) may determine that a geographic area is affected by an emergency situation and, in response, retrieve the emergency locations of users associated with the geographic area. The computing device(s) may provide those emergency locations and locations of at least one of NTNs or non-fixed TNs to the emergency coverage assessor and receive the instructions from the emergency coverage assessor to redeploy an NTN or non-fixed TN. The computing device(s) may send sending those instructions to the NTN or non-fixed TN or to a service managing the NTN or non-fixed TN.

In various implementations, the emergency locations of the users can include current locations or predicted locations. Current locations may be obtained by user equipments (UEs) of the users and may include global positioning system (GPS) location for a user, a location of a most recent access point for a user, or a location determined using access point triangulation. Predicted locations may also be obtained from UEs or may be obtained from other systems and may include a destination location entered into an application by a user (e.g., a destination input into a map application), a destination location predicted for a user by an application (e.g., a user's home, at a time of day that a user typically drives home), an emergency location registered by the user (e.g., an emergency location entered by the user when signing up for telecommunications services), a location of other users in the geographic area (e.g., a location nearby with a great number of users), or a location from social media (e.g., a location listed as an evacuation site on a government social media post).

The emergency coverage assessor may be an artificial intelligence (AI) component, such as a generative AI component, a combination of a dashboard a human analyst viewing information on the dashboard and providing responsive inputs through it, or some combination of both the AI component and the dashboard/human analyst.

In various implementations, the NTNs and non-fixed TNs that are redeployed based on instructions from the emergency coverage assessor include any mobile radio equipment providing coverage using licensed or unlicensed spectrum over radio waves or using any other medium capable of carrying information from one device to another wirelessly. Examples of NTNs may include satellites and drones. A vehicular TN, such as a vehicle providing wireless coverage to nearby devices, is an example of a non-fixed TN. In some examples, NTNs and non-fixed TNs may be chained in a sequence—e.g., a vehicular TN that talks to a core network through a satellite NTN.

In some implementations, connectivity may be provided by multiple network operators working together. For example, the NTNs may be operated by a different entity than service provider than the UEs are subscribed with. That service provider, operating the core network, may partner with the operator of the NTNs to provide coverage to their subscribers.

In various implementations, the emergency situation may continue for some time, and NTNs and non-fixed TNs may need to be redeployed more than once. A shelter, for example may begin to be affected by a natural disaster, and users may need to move to another shelter. Thus, either periodically or on an event driven basis, the computing device(s) may repeat the retrieval of emergency locations, the providing of locations to an emergency coverage assessor, the receiving of instructions to redeploy NTNs and/or non-fixed TNs, and the sending of those instructions for implementation by the NTNs and/or non-fixed TNs.

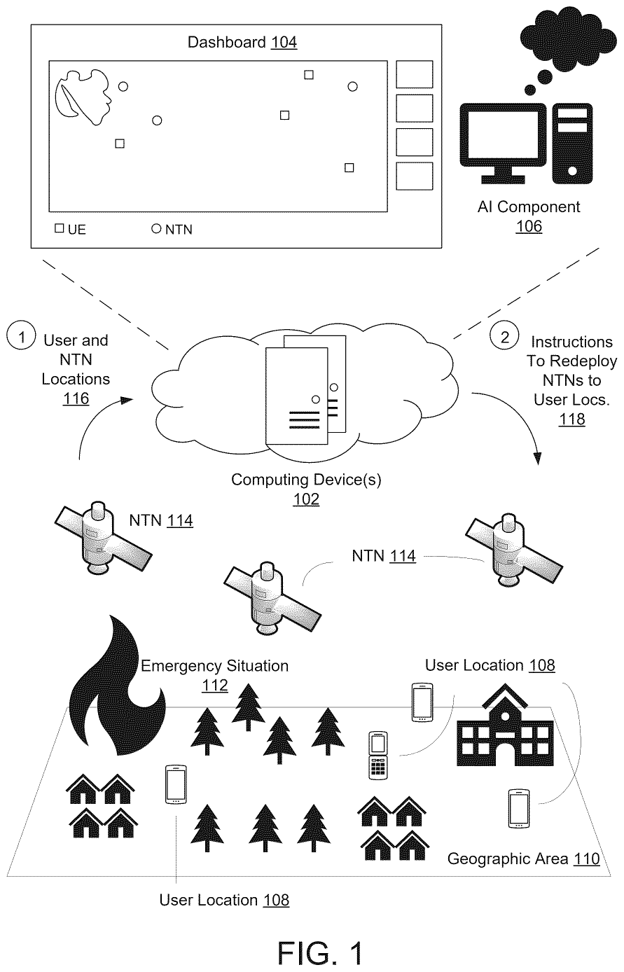

FIG. 1 is an overview diagram showing an emergency coverage assessor retrieving emergency locations of users in an emergency situation and, based on those emergency locations and locations of NTNs and/or non-fixed TNs, providing instructions to redeploy those NTNs and/or non-fixed TNs to provide coverage for the users at their emergency locations. As illustrated, computing device(s) 102 may provide locations to an emergency coverage assessor, such as a dashboard 104 and human analyst, an AI component 106, or a combination of both. The locations may be emergency locations of users (“user locations 108”) in a geographic area 110 during an emergency situation 112. The locations may also include locations of NTNs and/or non-fixed TNs (“NTNs 114”). These locations may be retrieved, at 116, by the computing device(s) 102 and provided to the emergency coverage assessor. Instructions to redeploy the NTNs 114 are received in response and provided, at 118, to cause the NTNs 114 to redeploy to at least one user location 108.

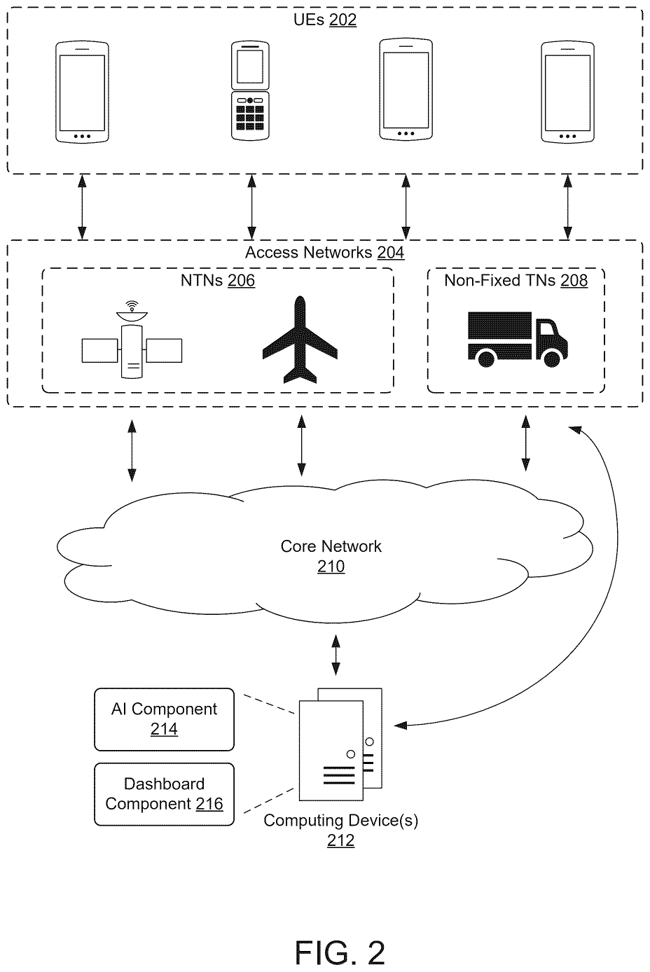

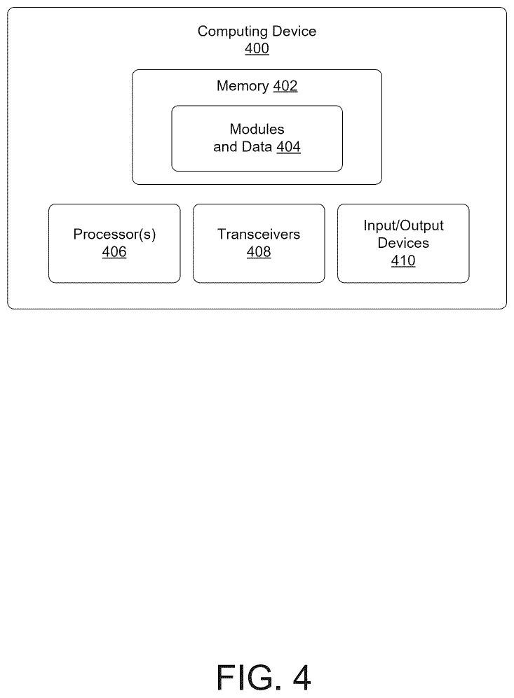

In various implementations, the computing device(s) 102 may be any sort of computer systems, including personal computers (PCs), laptop computers, tablet computers, cellular devices, server computers, mainframe computers, etc. The computing device(s) 102 may also include virtual machines operating on physical computing devices. Additionally, the computing device(s) may be located on a single network or spread across multiple networks and may have a single network operator or by device(s) of multiple network operators working together. The computing device(s) 102 may belong to an access network, such as one of the NTNs or non-fixed TNs, to a core network, or may be external to a telecommunications network. Example computing device(s) 102 are shown in FIGS. 2 and 4 and described with reference to those figures in greater detail herein.

As shown in FIG. 1, the computing device(s) 102 may include one or both of a dashboard 104 or AI component 106 or may invoke either or both of the dashboard 104 or AI component 106 on other system(s). The dashboard 104 may be associated with logic which takes user locations 108 and locations of NTNs 114 as inputs, along with map data and various other sources of input and renders to a display a graphic representation comprising the dashboard 104. The dashboard 104 may include a map displaying the user locations 108 and the locations of the NTNs 114 and may include facilities for manipulating the map—e.g., dragging a representation of an NTN 114 to a representation of a user location 108. The logic associated with the dashboard 104 may then receive those inputs and provide the new/selected NTN location(s) as instructions for redeploying the NTN(s) 114 to other component(s) of the computing device(s) 102. The interactions with the dashboard 104—viewing and providing input through it—may be performed by a human analyst, such as a person associated with an operator of a telecommunications network providing service to UEs associated with the users at the user locations 108, an operator of the NTNs 114, or an operator of both the telecommunications network and the NTNs (which may or may not be part of the telecommunications network).

The AI component 106 may be any sort of AI instance, such as a generative AI with a large language model (LLM) trained with data associated with the telecommunications network, with data associated with the users at the user locations 108, with data associated with the geographic area 110, with data associated with similar emergency situations to the emergency situation 112, and/or with data associated with the NTNs 114. The AI component 106 may take the user locations 108 and locations of the NTNs 114 as inputs and provide, as output, instructions for redeployment of the NTNs 114.

In various implementations, the UEs of the users at the user locations 108 may be any sort of wireless communication devices, such as cellular phones, tablet computers, Internet-of-Things (IoT) devices (e.g., a watch, glasses, goggles, etc.), gaming devices, etc. The users at the user locations 108 may subscribe for services of an operator of a telecommunications network that operates or is associated with an operator of the NTNs 114 and may use their UEs to access those services.

As mentioned herein, NTNs 114 includes both NTNs and non-fixed TNs. Examples of NTNs include satellites, including low-orbiting satellites, drones, aircraft, etc. Examples of non-fixed TNs include vehicular base stations, such as special-purpose vehicles designed to serve as mobile base stations and commercial vehicles capable of acting as a hot-spot and communicating to, e.g., NTNs or other base stations.

In various implementations, the context in which the computing device(s) 102 are performing services—an emergency situation 112—may cover any sort of emergency situation 112, especially an emergency situation 112 which is likely to result in movements of users to different locations. For example, earthquakes, tsunamis, hurricanes, tornados, forest fires, etc. may all result in evacuations and consequent movement of users to user locations 108 that may not be known in advance by those users or by providers of telecommunications services. Consequently, access networks, such as fixed location TNs (e.g., cell towers) and NTNs 114 may not be located where users are being sent—e.g., a shelter. Even if some of them are located at user locations 108, they may not provide sufficient coverage for the users converging there. Hence, the success of providing coverage may be enhanced by redeploying NTNs 114 to where users are or are going (user locations 108).

In the example shown in FIG. 1, the emergency situation 112 in the geographic area 110 is a forest fire, and users with their UEs are moving locations to what may be a shelter—a building that looks like a school. The users and UEs are at user locations 108 that are spread throughout the geographic area 110—some may be only current locations, with a user driving somewhere else, others may be predicted locations, such as destinations that have been input to a map application for directions.

FIG. 1 further shows, at 116, the computing device(s) retrieving the user locations 108 and locations of NTNs 114. The retrieving at 116 may be triggered by a determination that an emergency situation 112 is ongoing in a geographic area 110. This determination may be automatically triggered by one or more sensors or by receiving alerts (e.g., from a government entity), may be entered by a user, etc. Regardless of how the emergency situation 112 and associated geographic area 110 are determined, a next operation may be to retrieve, at 116, the user locations 108 of users in the geographic area 110.

Retrieving, at 116, user locations 108 may include retrieving current locations of users in the geographic area 110, predicted locations, or both. Current locations may be determined by UEs of the users based on GPS sensors in the UEs, based on triangulation among locations of access points visible to those UEs, or may be obtained from other UEs in, e.g., a Bluetooth or other local range from the UEs. The predicted locations may likewise be obtained from the UEs of the users based on, e.g., a location entered into an application by a user (e.g., a destination entered into a map application), a destination location predicted for a user by an application (e.g., a user's home, at a time of day that a user typically drives home), an emergency location registered by the user (e.g., an emergency location entered by the user when signing up for telecommunications services), a location of other users in the geographic area (e.g., a location nearby with a great number of users), or a location from social media (e.g., a location listed as an evacuation site on a government social media post). Any of these current locations, predicted locations, or both, may be retrieved from the UEs in the geographic area 110 and based on any rules or filtering applied by the computing device(s) 102 may be deemed the user locations 108.

The locations of the NTNs 114 may be known to the computing device(s) 102 based on information received from their operator. That information may be received periodically, on a pull basis, on an event-driven basis, etc. Once the computing device(s) 102 have retrieved and/or received the user locations 108 and locations of the NTNs 114, the computing device(s) 102 may provide the user locations 108 and locations of the NTNs 114 to the emergency coverage assessor. As noted herein, providing to the emergency coverage assessor may include providing user locations 108 and locations of the NTNs 114 to the dashboard 104 and its logic, to the AI component 106, or both.

At 118, the computing device(s) 102 receive instructions to redeploy one or more of the NTNs 114 to user locations 108. The user locations 108 named in the instructions may include multiple user locations, with different NTNs 114 being sent to those multiple user locations, or a single common user location, with one or more NTNs 114 sent to that common location. These instructions may then be sent, at 118, to the NTNs 114 or to a server managing the NTNs 114. In some implementations, the NTNs 114 may be operated by a different entity than the entity associated with the computing device(s) 102. For example, the computing devices(s) 102 may be associated with a telecommunications network operator and the NTNs 114 may be associated with, e.g., an operator of satellite systems. When multiple entities are involved, instructions may be communicated as requests or as directions depending on the relationship between the entities and the technical equipment used to effectuate transmission of instructions and redeployment of NTNs 114.

Periodically or on an event-driven basis, the computing device(s) 102 may repeat their determination of the emergency situation 112. Alternatively, the computing device(s) 102 may determine that the emergency situation is ongoing until they receive a message or direction indicating that the emergency situation 112 is over/completed. While the emergency situation 112 is ongoing, the computing device(s) 102 may repeat, periodically or on an event-driven basis, the retrieving at 116 and the sending at 118.

FIG. 2 is a network architecture diagram of user equipments (UEs), NTNs and/or non-fixed TNs providing coverage to those UEs, a core network connecting to the access networks provided by the NTNs and/or non-fixed TNs, and one or more computing device(s) using emergency locations of UEs and locations of NTNs and/or fixed TNs to redeploy the NTNs and/or non-fixed TNs to the emergency locations of the UEs.

As illustrated, UEs 202 communicate wirelessly with access networks 204, including NTNs 206 and/or non-fixed TNs 208 and, through the access networks 204, to one or more nodes of the core network 210. Either those nodes of the core network 210 or another system, such as a server external to the access networks 204 and core network 210 or other communication devices (e.g., other UEs) may be a destination communication partner for the UEs 202. As part of establishing connections with the access networks 204 and core network 210, the UEs 202 may provide their current locations. These locations, or other UE locations (e.g., predicted locations) may be retrieved from the UEs 202 by the computing device(s) 212.

The UEs 202 may be examples of the UEs discussed above with reference to the user locations 108. The NTNs 206 and non-fixed TNs 208 may be examples of the NTNs 114 discussed above with respect to FIG. 1. The computing device(s) 212 may be examples of the computing devices(s) 102, the AI component 214 may be an example of the AI component 106, and the dashboard 216 may be an example of the dashboard 104. The core network 210 may be any sort of core network, such as an evolved packet core (EPC), a Fifth Generation (5G) core network, a Sixth Generation (6G) core network, etc. and it may include or be associated with an Internet multimedia subsystem (IMS), which may include an emergency call session control function (E-CSCF) that may be involved in determining an emergency situation, such as emergency situation 112.

The UEs 202 and access networks 204 may use any sort of wireless communication, such as communication over one or more radio frequencies. The access networks 204 and core network 210 may communicate over a backhaul, such as a wired backhaul (e.g., Ethernet cables), a wireless backhaul, or a combination thereof. The computing device(s) 212 may be part of the core network 210, an access network 204 or may be separate from both an connect over the Internet, a public network, or a private network.

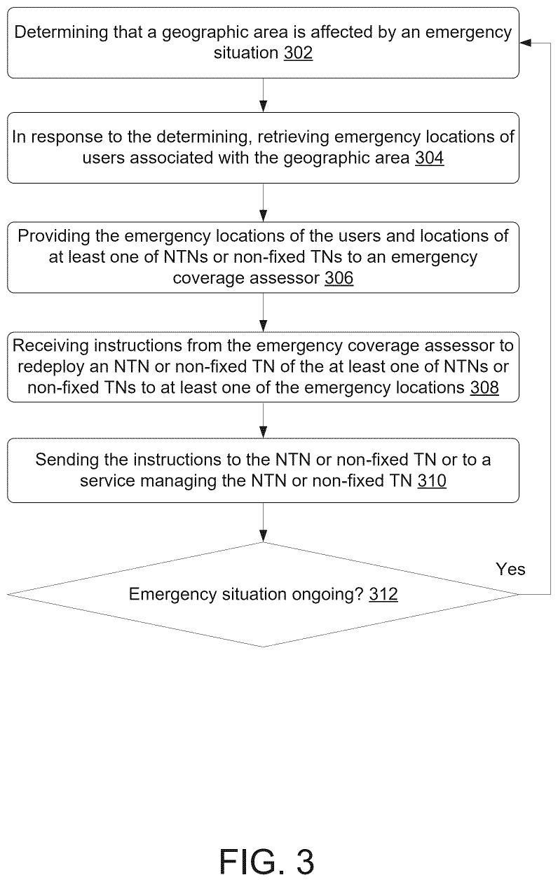

FIG. 3 illustrates an example process. This process is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 3 is a flow diagram of an illustrative process for retrieving emergency locations of users affected by an emergency situation, providing those locations and locations of NTNs or non-fixed TNs to an emergency coverage assessor, receiving instructions from the emergency coverage assessor to redeploy an NTN or non-fixed TN, and sending those instructions to the NTN or non-fixed TN. As illustrated at 302, one or more computing devices determine that a geographic area is affected by an emergency situation.

At 304, in response to the determining at 302, the computing device(s) retrieve emergency locations of users associated with the geographic area. In some implementations, the emergency locations may include at least one of a current location of a user or a predicted location of a user. A current location of a user may be a GPS location for a user, a location of a most recent access point for a user, or a location determined using access point triangulation. A predicted location of a user may be a destination location entered into an application by a user, a destination location predicted for a user by an application, an emergency location registered by ta user, a location of other users in the geographic area, or a location from social media.

At 306, the computing device(s) provide the emergency locations of the users and locations of at least one of NTNs or non-fixed TNs to an emergency coverage assessor. In some implementations, the emergency coverage assessor may be an AI component, an analyst using a dashboard that shows the emergency locations, or a combination of the AI component and the analyst using the dashboard. Further, the NTNs may include at least one of satellites and drones. Also, the non-fixed TNs may include vehicular TNs.

At 308, the computing device(s) receive instructions from the emergency coverage assessor to redeploy an NTN or non-fixed TN of the at least one of NTNs or non-fixed TNs. In some implementations, the computing device(s) may be associated with an entity offering at least one of access network services and core network services and at least the providing at 306 and the receiving at 308 are coordinated with a partner provider offering the other of access network services and core network services.

At 310, the computing device(s) send the instructions to the NTN or non-fixed TN or to a service managing the NTN or non-fixed TN.

At 312, the computing device(s) may determine whether the emergency situation is ongoing and, if ongoing, may repeat at least the retrieving at 304 and the providing at 306. In some implementations, the computing device(s) may periodically or repeatedly perform at least the retrieving at 304 and the providing at 306 while the geographic area is affected by the emergency situation.

FIG. 4 is a schematic diagram of a computing device capable of implementing functionality of at least one of the systems described herein. As shown, the computing device 400 includes a memory 402 storing modules and data 404, processor(s) 406, transceivers 408, and input/output devices 410.

In various examples, the memory 402 can include system memory, which may be volatile (such as RAM), non-volatile (such as ROM, flash memory, etc.) or some combination of the two. The memory 402 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 402 can include one or more software or firmware elements, such as computer-readable instructions that are executable by the one or more processors 406. For example, the memory 402 can store computer-executable instructions associated with modules and data 404. The modules and data 404 can include a platform, operating system, and applications, and data utilized by the platform, operating system, and applications. Further, the modules and data 404 can implement any of the functionality for the devices and components described and illustrated herein.

In various examples, the processor(s) 406 can be a central processing unit (CPU), a graphics processing unit (GPU), or both CPU and GPU, or any other type of processing unit. Each of the one or more processor(s) 406 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 406 may also be responsible for executing all computer applications stored in the memory 402, which can be associated with types of volatile (RAM) and/or nonvolatile (ROM) memory.

The transceivers 408 can include modems, interfaces, antennas, Ethernet ports, cable interface components, and/or other components that perform or assist in exchanging wireless communications, wired communications, or both.

While the computing device need not include input/output devices 410, in some implementations it may include one, some, or all of these. For example, the input/output devices 410 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 410 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 410 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

Also, while the descriptions provided herein may be in the context of certain radio access technologies, networks, and network topologies, such as Fifth Generation (5G)/new radio (NR) mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and NTN communications. Thus, the scope of the disclosure is not limited to the examples described herein.

What is claimed is:

1. A method comprising:
determining, by one or more computing devices, that a geographic area is affected by an emergency situation;
in response to the determining, retrieving, by the one or more computing devices, emergency locations of users associated with the geographic area;
providing, by the one or more computing devices, the emergency locations of the users and locations of at least one of non-terrestrial networks (NTNs) or non-fixed terrestrial networks (TNs) to an emergency coverage assessor;
receiving, by the one or more computing devices, instructions from the emergency coverage assessor to redeploy an NTN or non-fixed TN of the at least one of NTNs or non-fixed TNs to at least one of the emergency locations; and
sending, by the one or more computing devices, the instructions to the NTN or non-fixed TN or to a service managing the NTN or non-fixed TN.

2. The method of claim 1, wherein the emergency locations include at least one of a current location of a user or a predicted location of a user.

3. The method of claim 2, wherein the current location is a global positioning system (GPS) location for a user, a location of a most recent access point for a user, or a location determined using access point triangulation.

4. The method of claim 2, wherein the predicted location is a destination location entered into an application by a user, a destination location predicted for a user by an application, an emergency location registered by ta user, a location of other users in the geographic area, or a location from social media.

5. The method of claim 1, further comprising periodically or repeatedly performing at least the retrieving and the providing while the geographic area is affected by the emergency situation.

6. The method of claim 1, wherein the emergency coverage assessor is an artificial intelligence (AI) component, analyst using a dashboard that shows the emergency locations, or a combination of the AI component and the analyst using the dashboard.

7. The method of claim 1, wherein the one or more computing devices are associated with an entity offering at least one of access network services and core network services and at least the providing and the receiving are coordinated with a partner provider offering the other of access network services and core network services.

8. The method of claim 1, wherein the NTNs include at least one of satellites and drones.

9. The method of claim 1, wherein the non-fixed TNs include vehicular TNs.

10. A system comprising:
one or more processors; and
programming instructions that, when executed by the one or more processors on one or more computing devices, cause the one or more computing devices to perform operations including:
determining that a geographic area is affected by an emergency situation;
in response to the determining, retrieving emergency locations of users associated with the geographic area;
providing the emergency locations of the users and locations of at least one of non-terrestrial networks (NTNs) or non-fixed terrestrial networks (TNs) to an emergency coverage assessor;
receiving instructions from the emergency coverage assessor to redeploy an NTN or non-fixed TN of the at least one of NTNs or non-fixed TNs to at least one of the emergency locations; and
sending the instructions to the NTN or non-fixed TN or to a service managing the NTN or non-fixed TN.

11. The system of claim 10, wherein the emergency locations include at least one of a current location of a user or a predicted location of a user.

12. The system of claim 11, wherein the current location is a global positioning system (GPS) location for a user, a location of a most recent access point for a user, or a location determined using access point triangulation.

13. The system of claim 11, wherein the predicted location is a destination location entered into an application by a user, a destination location predicted for a user by an application, an emergency location registered by ta user, a location of other users in the geographic area, or a location from social media.

14. The system of claim 10, wherein the operations further include periodically or repeatedly performing at least the retrieving and the providing while the geographic area is affected by the emergency situation.

15. The system of claim 10, wherein the emergency coverage assessor is an artificial intelligence (AI) component, an analyst using a dashboard that shows the emergency locations, or a combination of the AI component and the analyst using the dashboard.

16. The system of claim 10, wherein the NTNs include at least one of satellites and drones, or the non-fixed TNs include vehicular TNs.

17. A non-transitory computer storage medium having stored thereon programming instructions that, when executed by one or more processors on one or more computing devices, cause the one or more computing devices to perform operations comprising:
determining that a geographic area is affected by an emergency situation;
in response to the determining, retrieving emergency locations of users associated with the geographic area;
providing the emergency locations of the users and locations of at least one of non-terrestrial networks (NTNs) or non-fixed terrestrial networks (TNs) to an emergency coverage assessor;
receiving instructions from the emergency coverage assessor to redeploy an NTN or non-fixed TN of the at least one of NTNs or non-fixed TNs to at least one of the emergency locations; and
sending the instructions to the NTN or non-fixed TN or to a service managing the NTN or non-fixed TN.

18. The non-transitory computer storage medium of claim 17, wherein the emergency locations include at least one of:
a current location of the user, wherein the current location is a global positioning system (GPS) location for a user, a location of a most recent access point for a user, or a location determined using access point triangulation; or
a predicted location of the user, wherein the predicted location is a destination location entered into an application by a user, a destination location predicted for a user by an application, an emergency location registered by ta user, a location of other users in the geographic area, or a location from social media.

19. The non-transitory computer storage medium of claim 17, wherein the operations further comprise periodically or repeatedly performing at least the retrieving and the providing while the geographic area is affected by the emergency situation.

20. The non-transitory computer storage medium of claim 17, wherein the emergency coverage assessor is an artificial intelligence (AI) component, an analyst using a dashboard that shows the emergency locations, or a combination of the AI component and the analyst using the dashboard.
